(19) United States
(12) Patent Application Publication
(10) Pub. No.: US 2015/0169258 A1
(43) Pub. Date: Jun. 18, 2015

(54) PRINTING SYSTEM AND METHOD FOR CONTROLLING THE PRINTING SYSTEM

(71) Applicant: CANON KABUSHIKI KAISHA, Tokyo (JP)

(72) Inventor: Hiroyuki Nakane, Yokohama-shi (JP)

(21) Appl. No.: 14/567,996

(22) Filed: Dec. 11, 2014

(30) Foreign Application Priority Data
Dec. 18, 2013 (JP) 2013-261496

(51) Int. Cl. G06F 3/12

(52) U.S. Cl. CPC G06F 3/1204; G06F 3/1254; G06F 3/1273

(57) ABSTRACT

A printing control apparatus transmits a result of analyzing image data acquired by imaging a print product and the image data to an information processing apparatus. The information processing apparatus stores original data used for printing and determines print setting information set for printing the imaged print product based on the image data received from the printing control apparatus and the result of analysis. Furthermore, the information processing apparatus searches for the original data based on the image data, and transmits the original data found by the information processing apparatus, and the determined print setting information to the printing control apparatus.

### BACKGROUND OF THE INVENTION

1. Field of the Invention

The present invention relates to a printing system that determines print setting information based on captured image data of a print product, and a method for controlling the printing system.

2. Description of the Related Art

Japanese Patent Application Laid-Open No. 2007-179482 discusses a technique for easily executing reprinting in a printing process. The technique discussed therein associates a print image with print setting information and manages the image when a printing apparatus receives a request for printing. When the printing apparatus is instructed to perform reprinting, the printing apparatus uses the print setting information associated with the print image to be reprinted to allow reducing a burden for a user setting the print setting information at the reprinting, which can improve operability.

However, the technique discussed in Japanese Patent Application Laid-Open No. 2007-179482 has the following problem. If the same print image is printed a plurality of times using different pieces of print setting information, a plurality of combinations between the print image and the print setting information is managed, even if the print image is the same. As a result, when the user executes reprinting, the user has to search for a desired combination. As a result, it may be difficult to reduce an operation burden to the user.

### SUMMARY OF THE INVENTION

According to an aspect of the present invention, in a printing system including a printing control apparatus and an information processing apparatus, the printing control apparatus includes a printing unit configured to print a print product, an imaging unit configured to image the print product, and a transmission unit configured to transmit a result of analyzing image data acquired by imaging the print product and the image data to the information processing apparatus, and the information processing apparatus includes a storage unit configured to store original data used for printing, a determination unit configured to determine print setting information set for printing the imaged print product based on the image data and the result of analysis, a search unit configured to search for the original data based on the image data, and a data transmission unit configured to transmit the original data found by the search unit and the determined print setting information to the printing control apparatus, in which the printing unit prints the print product based on the original data and the print setting information.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration according to a first exemplary embodiment.

FIG. 2 is a block diagram illustrating software modules according to the first exemplary embodiment.

FIG. 3 is a flow chart illustrating a process performed by a printing control apparatus according to the first exemplary embodiment.

FIG. 4 is a flow chart illustrating a process performed in step S302 according to the first exemplary embodiment.

FIG. 5 illustrates images obtained before and after the external form of a print product is acquired according to the first exemplary embodiment.

FIGS. 6A and 6B illustrate examples of print setting control tables according to the first and a second exemplary embodiment.

FIGS. 7A and 7B illustrate examples of preview images displayed by the printing control apparatus according to the first exemplary embodiment.

FIG. 8 is a flow chart illustrating a process performed by an information processing apparatus according to the first exemplary embodiment.

FIG. 9 illustrates images at an aggregate print according to the first exemplary embodiment.

FIG. 10 is a flow chart illustrating a process in step S805 according to the first exemplary embodiment.

FIG. 11 is a flow chart illustrating a process in step S306 according to the second exemplary embodiment.

FIGS. 12A and 12B illustrate examples of preview images displayed by the printing control apparatus according to the second exemplary embodiment.

### DESCRIPTION OF THE EMBODIMENTS

Various exemplary embodiments, features, and aspects of the invention will be described in detail below with reference to the drawings.

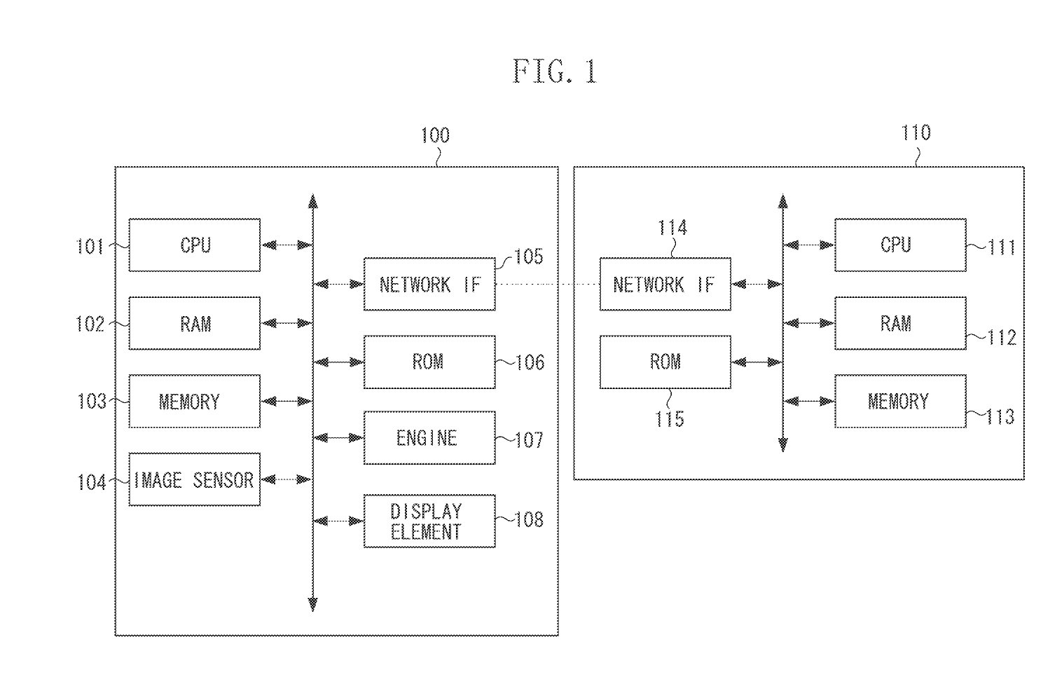

FIG. 1 is a block diagram illustrating an example of a hardware configuration of a printing control apparatus 100 and an information processing apparatus 110 according to a first exemplary embodiment of the present invention. The present exemplary embodiment is realized by a printing system including the printing control apparatus 100 and the information processing apparatus 110. The printing control apparatus 100 is an apparatus (e.g., printer and multifunction peripheral) for imaging a print product and transferring an image result and hint information (described below) to the information processing apparatus 110. The information processing apparatus 110 searches for original data and print setting information based on the transferred image result and hint information and transfers a search result to the printing control apparatus 100. The printing control apparatus 100 can display the print setting information transferred from the information processing apparatus 110 for the user and receive a change of the print setting information from the user.

A central processing unit (CPU) 101 is included in the printing control apparatus 100. Software 200 of the printing control apparatus 100 described below operates on the CPU 101. A random access memory (RAM) 102 can be accessed by the CPU 101. The RAM 102 is used as an area where the memory required for operating the software 200 of the printing control apparatus 100 described below is reserved. An engine 107 is a printing engine which receives print data based on original data from the printing control apparatus 100 via a network interface (IF) 105 and prints the print data interpreted by the CPU 101 on printing paper. The network IF 105 is an interface connected with an external apparatus (e.g., information processing apparatus 110) via the network to transmit and receive data. A read only memory (ROM) 106 is included in the printing control apparatus 100. A program in the software 200 of the printing control apparatus 100 described below is stored in the ROM 106. The program is read by the CPU 101 and executed. A memory 103 is an area for storing a large volume of data such as images described below (or image feature quantity) and plays a subsidiary role of the RAM 102. In the present exemplary embodiment, even though the memory 103 is specified for convenience of explanation, the memory 103 is not required if a capacity of the RAM 102 is sufficiently large. Alternatively, an external hardware (storage) may be connected to the printing control apparatus 100 via the network IF 105 of the printing control apparatus 100. An image sensor 104 is hardware for capturing an image of a print product. The captured image is stored in the RAM 102 or the memory 103 by the CPU 101. It is desirable for the image sensor 104 to include an infrared irradiation device and an infrared sensor to obtain an effect of high accuracy, but the present invention is not limited thereto. A display element 108 is hardware for displaying information for the user. Information stored in the RAM 102 or the memory 103 or information received from the outside via the network IF 105 can be displayed on the display element 108 according to the control of the CPU 101. The display element 108 is provided with a function to receive a request as to the displayed information from the user. The function may be a touch panel display as a more specific example. The image sensor 104 and the display element 108 form a part of the printing control apparatus 100. However, the image sensor 104 and the display element 108 may be replaced with an external information terminal with the same hardware. In that case, communication between the CPU 101 and other hardware is performed via the network IF 105.

A CPU 111 is included in an information processing apparatus 110. Software 210 of the information processing apparatus 110 described below is executed by the CPU 111. A RAM 112 can be accessed by the CPU 111. The RAM 112 is used as an area where a memory required for operating the software 210 of the information processing apparatus 110 described below is secured. A memory 113 is an area for storing image data to be searched. The image data is rasterized at the time of printing by the printing control apparatus 100 or another printing control apparatus connected outside. The image data is managed in association with original data at the time of generating a print image in printing. The print image generated by the information processing apparatus 110 or another printing control apparatus (not illustrated) connected via a network IF 114 is stored in the memory 113. The memory 113 used as an area for storing the print image may be replaced by the RAM 112 as long as a memory size of the RAM 112 is sufficiently large or by an external memory connected via the network IF 114. The network IF 114 is an interface for connecting the information processing apparatus 110 with the printing control apparatus 100 via the network, and transmits and receives data. A ROM 115 is included in the information processing apparatus 110. A program of the software 210 of the information processing apparatus described below is stored in the ROM 115. The program is read by the CPU 111 and executed.

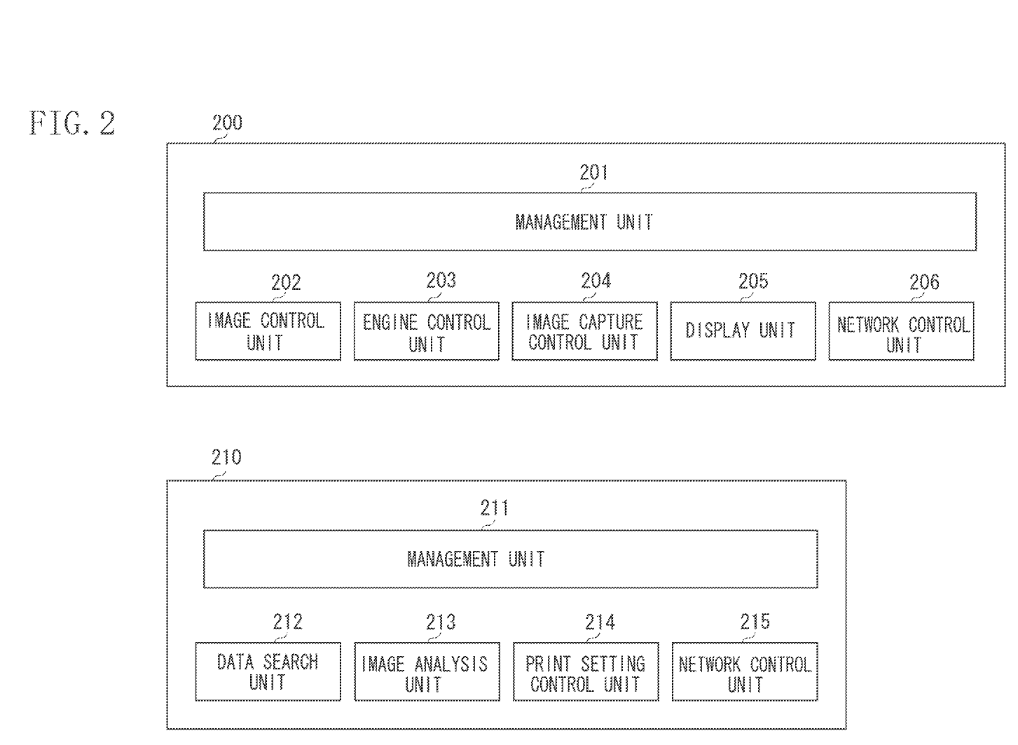

FIG. 2 illustrates an example of a software configuration of the printing control apparatus 100 and the information processing apparatus 110 according to the first exemplary embodiment of the present invention.

The software 200 of the printing control apparatus 100 is formed of six software modules, all of which are operated on the CPU 101. A management unit 201 is a module for managing total processing of the printing control apparatus 100. An image control unit 202 is a module for receiving a print instruction for the printing control apparatus 100 and generating image data for printing. The generated image data is processed by an engine control unit 203 described below and is output as a print product. The image control unit 202 is also a module for performing image analysis on the image captured by an image capture control unit 204 described below. The image capture control unit 204 is a module for imaging the print product by the CPU 101 controlling the image sensor 104. As described below, hint information used by the information processing apparatus 110 to determine print setting information is generated by the image capture control unit 204. A display unit 205 is a module for displaying information stored in the RAM 102 or the memory 103 or information from an external apparatus via the network IF 105. The display unit 205 is also a module for receiving a request to the displayed information from the user. A network control unit 206 is a module for controlling connection of the network and transmission and reception of data and transfers data via the network IF 105.

The software 210 of the information processing apparatus 110 is formed of five software modules, all of which can operate on the CPU 111. A management unit 211 is a module for managing total processing of the information processing apparatus 110. A data search unit 212 is a module for searching for and acquiring corresponding image data based on the image data received via the network IF 114. The data to be searched is stored in the memory 113 as described above. A detailed search method is described below. The corresponding image data, as described above, is managed in association with the original data input as print data. Therefore, the data search unit 212 can acquire not only the corresponding image data but also the original data at the same time. An image analysis unit 213 is a module for extracting the feature quantity of the image data received via the network IF 114, analyzing the image of the print product included in the image data, and determining the print setting information applied to the print product. A print setting control unit 214 generates the print setting information set at the time of printing the image of the print product included in the received image data based on the print setting information acquired by the image analysis unit 213 and the hint information received via the network IF 114. The print setting control unit 214 adds the generated print setting information to the original data acquired by the data search unit 212 according to the print instruction. A network control unit 215 is a module for controlling connection of the network and transmission and reception of data to exchange data via the network IF 114.

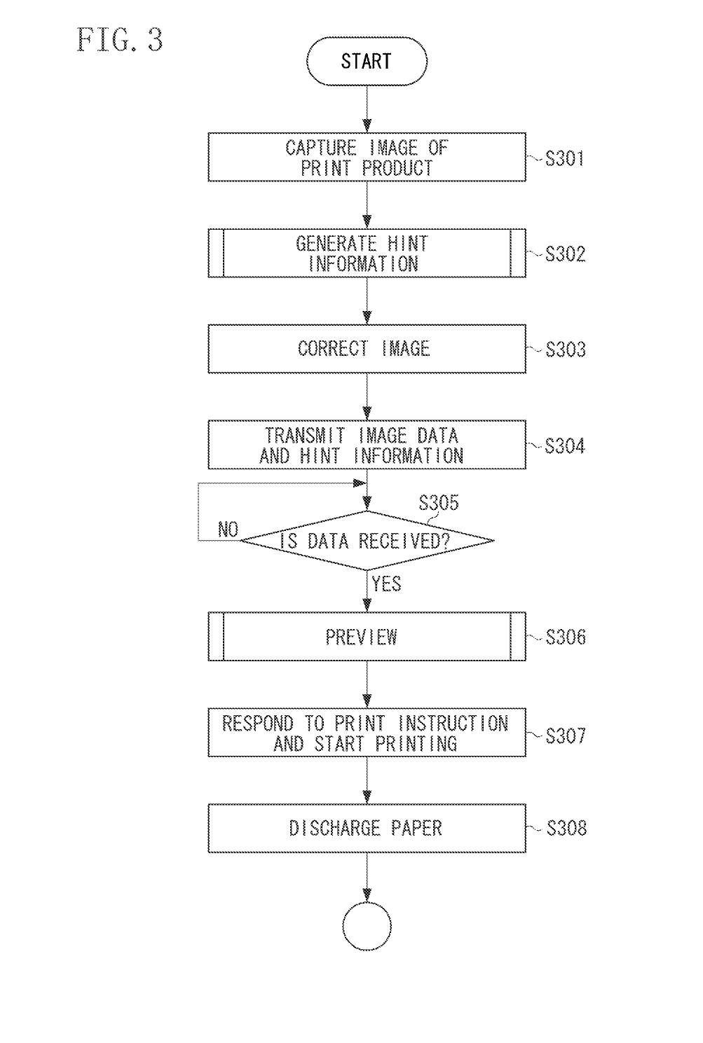

FIG. 3 is a flow chart illustrating an example of a process performed by the software 200 of the printing control apparatus 100 according to the first exemplary embodiment. The process illustrated in FIG. 3 is realized by the CPU 101 executing the program stored in the ROM 106. In the following flow chart, as a preferred example, the generated data is stored in the RAM 102 or the memory 103. However, there is no influence on the operation even if the data is stored without distinction.

In step S301, the image capture control unit 204 captures an image of a print product. The management unit 201 stores the captured image data and information about the apparatus at the time of capturing the image into the memory 103. The information about the apparatus refers to values of various sensors, which are parts of the image sensor, and the values are used for identifying the size of a print product included in the captured image in step S302 described below.

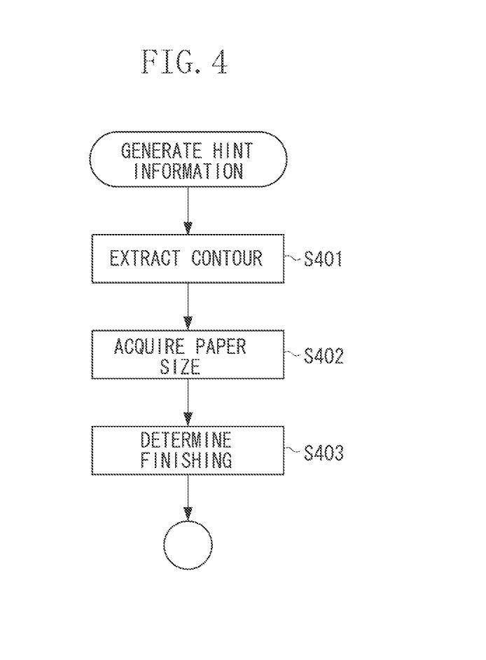

In step S302, the image capture control unit 204 generates the hint information for determining the print setting described below from the above-described captured image data and the information about the apparatus. A flow of step S302 is described below with reference to FIG. 4. The hint information refers to the print setting information acquired in steps S402 and S403 described below. The image capture control unit 204 stores the hint information in the memory 103.

In step S401, the image control unit 202 extracts an external form of the print product included in the captured image data.

In step S402, the image capture control unit 204 determines a paper size of the print product based on the external form extracted in step S401 and the above-mentioned information about the apparatus. Regarding a method for measuring the length from the external form included in the image data, a number of such techniques have been published. Thus, the detailed description thereof is omitted. For example, there is a method for measuring the length by the coordinates of a preliminarily fixed image sensor, and a phase difference detection method used by a camera with an auto-focus (AF) function.

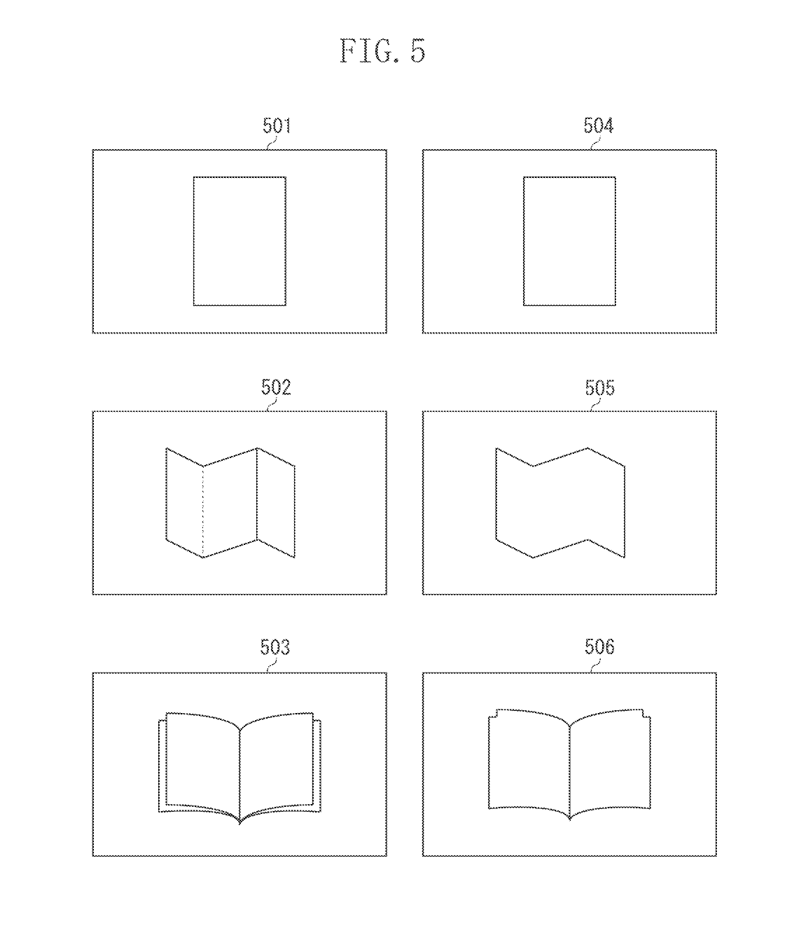

In step S403, the image capture control unit 204 determines a finishing setting of a targeted print product from the external form extracted in step S401. An example of the finishing setting is described below with reference to FIG. 5. Images 501 to 503 are examples of image data from which the external form is not yet extracted by the image control unit 202 in step S401. Images 504 to 506 are examples of image data from which the external form is extracted by the image control unit 202 in step S401. In the image 502, a portion indicated by a broken line indicates that a valley fold is made along a crease line. Whether the crease line is a valley or a mountain is determined by using a depth of the image data acquired using the technique described in step S402. The image 501 becomes a square like the image 504 acquired after the external form is extracted, so that the image capture control unit 204 determines that the print product should be normally finished (finishing setting is not required). The image 502 becomes a polygonal shape connected with straight lines like the image 505 acquired after the external form is extracted, so that the image capture control unit 204 determines that folding is set on the print product. Obviously, the external form can be different from that of the image 505 according to the number of folds and a folding method. The image capture control unit 204 matches a pattern with the acquired form (the image 505) for each of fold finishing setting items (folded inward in three, Z-folding, and others) to allow the fold finishing setting to be uniquely determined. For the image 503, after the external form is extracted, the image 506 is acquired. In the image 506, a part of the external form is curved due to deflection by bookbinding and any of four corners have a step-like form. The image capture control unit 204 extracts these features to determine that bookbinding is set on the print product. For the sake of simplicity, the present exemplary embodiment is described on the assumption that a finishing setting of the captured print product is set to the normal finishing. More specifically, in step S403, the finishing setting is determined as the normal finishing, fold setting, bookbinding setting or others. Now the description is back to FIG. 3 which illustrates the process of the printing control apparatus 100.

In step S303, the image control unit 202 corrects the captured image data by using projection transformation. The image control unit 202 calculates a homography matrix based on the paper size acquired in step S402 and the coordinate values of four corners of the external form extracted in step S401. The image control unit 202 accumulates the calculated homography matrix to each pixel in the external form so as to obtain the image mapped into the paper size acquired in step S402. The image control unit 202 stores the image generated by the image control unit 202 in the memory 103.

In step S304, the network control unit 206 transmits the image data corrected in step S303 and the hint information generated in step S302 to the information processing apparatus 110.

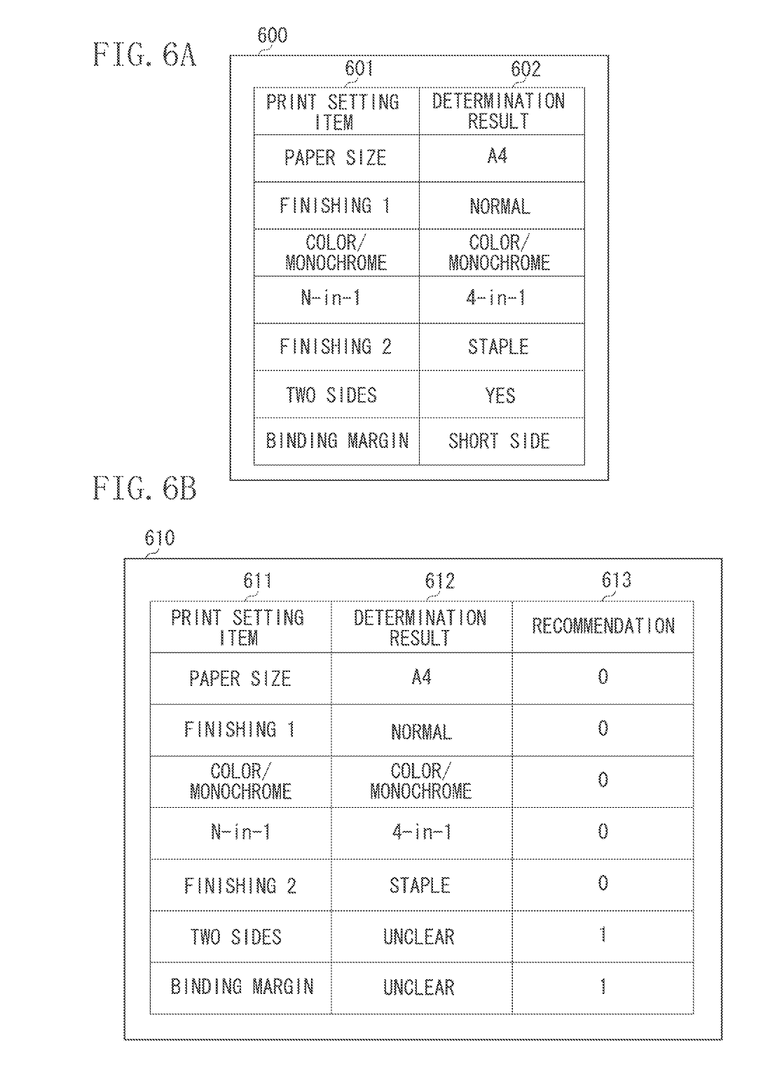

In step S305, the management unit 201 waits for data from the information processing apparatus 110. The data refers to the original data of the print product captured in step S301 and the print setting information applied to the print product whose image is captured. An example of the print setting information is illustrated in FIG. 6A. In the print setting information 600, a print setting item 601 includes a plurality of print setting items to be determined by the printing control apparatus 100 and the information processing apparatus 110. A determination result 602 refers to a setting value of the print setting information used for printing the print product whose image is captured in step S301. The process of the information processing apparatus 110 performed between steps S304 and S305 is described below. If the reception of the data is completed (YES in step S305), the process proceeds to step S306.

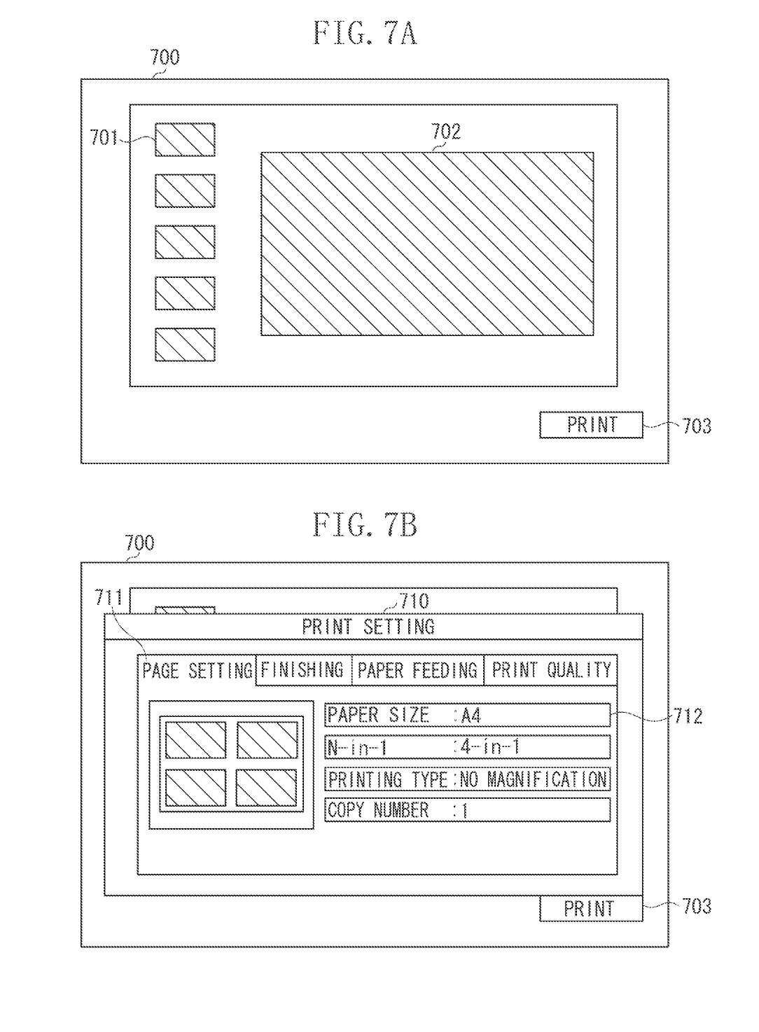

In step S306, the image control unit 202 performs the low resolution rendering on the received data and previews the rendering results. FIG. 7A illustrates the rendering results. A display panel 700 displays a screen in preview. An image 701 is a thumbnail image corresponding to an index page of the received data. The subsequent four rectangles thereunder are the thumbnail images of other pages. An image 702 is a preview image of the selected page. A print button 703 receives input from the user. If an input is made, the display unit 205 determines that a print instruction is issued, and starts the printing process. A low-resolution rendering is described here as an example to improve responsiveness of the preview. However, even if the preview is performed by a normal, high-resolution rendering, this does not affect an operation. The display unit 205 responds to a print instruction request from the user and displays a print setting window (setting screen) 710. An example of the window is illustrated in FIG. 7B. The print setting window 710 is displayed on the display panel 700. The print setting window 710 displays setting pairs for the print setting information for each tab and can receive a request by the user pressing the panel. For example, the user presses a page setting tab 711 to display the setting value of the print setting information related to the page setting. At present, the display panel 700 displays the setting value of the page setting tab 711 to allow the user to confirm the print setting information. Further, when the user presses a paper size button 712, the display unit 205 determines that the user makes a request for changing the paper size and displays settable paper sizes to the user. After the user confirms each item on the print setting window 710 and touches a print button 703 on the display unit 205, the display unit 205 receives the print instruction request from the user, and the process proceeds to step S307.

In step S307, the management unit 201 responds to the reception of the print instruction request from the display unit 205, and starts printing. The image control unit 202 generates the image data based on the original data received in step S305 and the print setting information confirmed (or changed) by the user on the display screen in step S306. The image data generated for printing may be transferred to the information processing apparatus 110.

In step S308, the engine control unit 203 outputs the image data generated in step S307 onto a sheet.

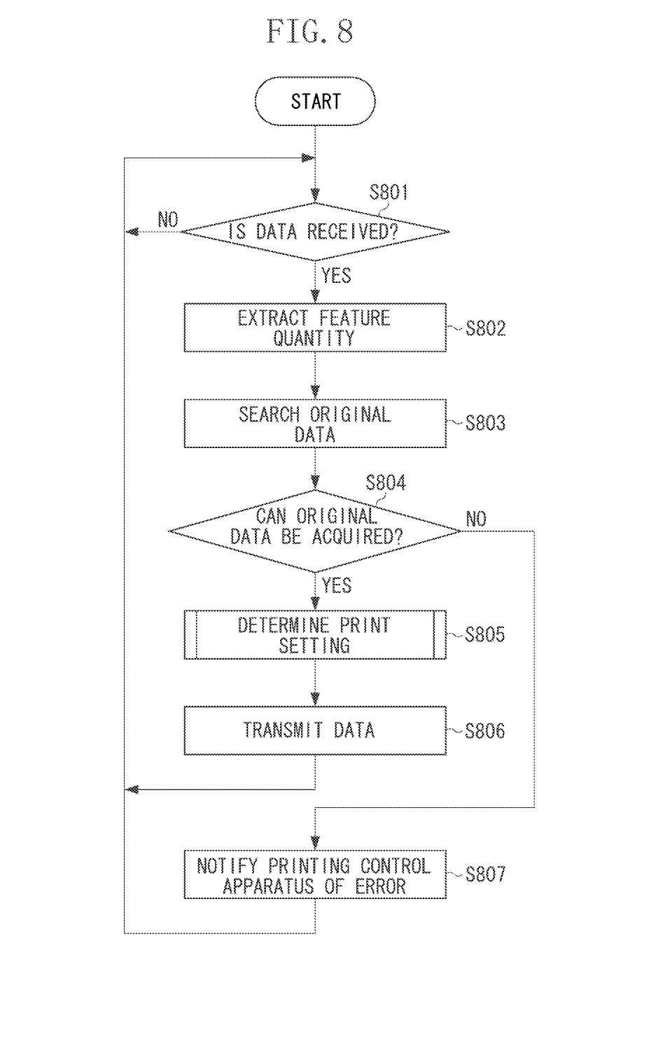

FIG. 8 is a flow chart illustrating an example of a process executed by the software 210 of the information processing apparatus 110 according to the first exemplary embodiment. The process illustrated in FIG. 8 is realized by the CPU 111 executing the program stored in the ROM 115. In the following flow chart, as a preferred example, the generated data is stored in the RAM 112 or the memory 113. However, this does not affect the operation even if the data is stored without distinction.

In step S801, the management unit 211 waits for receiving data from the printing control apparatus 100. The data refers to the image data and the hint information, which are transferred from the printing control apparatus 100 to the information processing apparatus 110 in step S304.

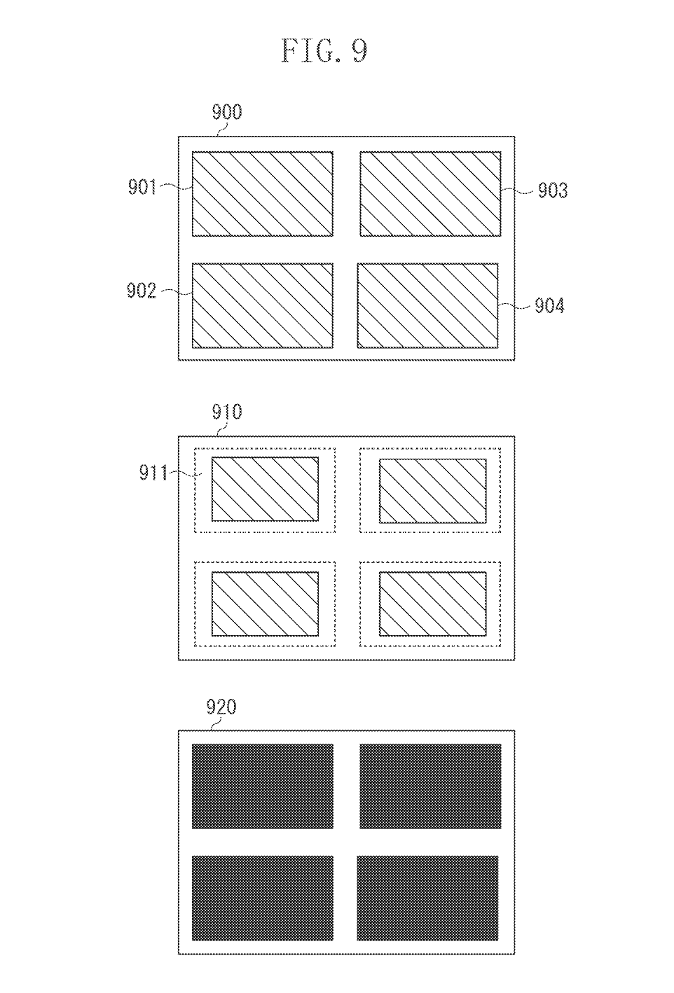

In step S802, the image analysis unit 213 calculates the feature quantity of the received image data. The present invention is not directed to a method for calculating the feature quantity, and a large number of known techniques regarding such a method have been published. Thus, the detailed description thereof is omitted. The feature quantity is acquired by speed-up robust features (SURF) algorithm to perform image searching as described below. Since the feature quantity is calculated to perform image searching, another algorithm such as scale-invariant feature transform (SIFT) may be used. In the present exemplary embodiment, an example in which N-in-1 (aggregate print) is set is described below. A method for calculating the feature quantity in a case where a target print product is set to 4-in-1, for example, is described below with reference to FIG. 9. An image 900 is an example of 4-in-1 printing in which four logic pages (901 to 904) are arranged in one physical page of the print product. In calculating the feature quantity, the image analysis unit 213 calculates the feature quantity from an area 911 illustrated in an image 910, which is slightly smaller than the logic page 901 to remove noise due to a boundary with a background area. The process is repetitively performed on the logic pages 902 to 904.

In step S803, the data search unit 212 performs matching on the original image data stored in the memory 113 to identify image data corresponding to the image feature quantity calculated in step S802 or most approximate image data within a threshold. Further, the data search unit 212 attempts to acquire the original data associated with the image data searched in step S803.

In step S804, the management unit 211 determines whether the data search unit 212 can acquire the original data. If the data search unit 212 can acquire the original data (YES in step S804), the process proceeds to step S805. If the data search unit 212 cannot acquire the original data (NO in step S804), the management unit 211 determines that an error occurs (failure in searching for the image, or no original data found) in step S807. The network control unit 215 notifies the printing control apparatus 100 of failure in searching for the image.

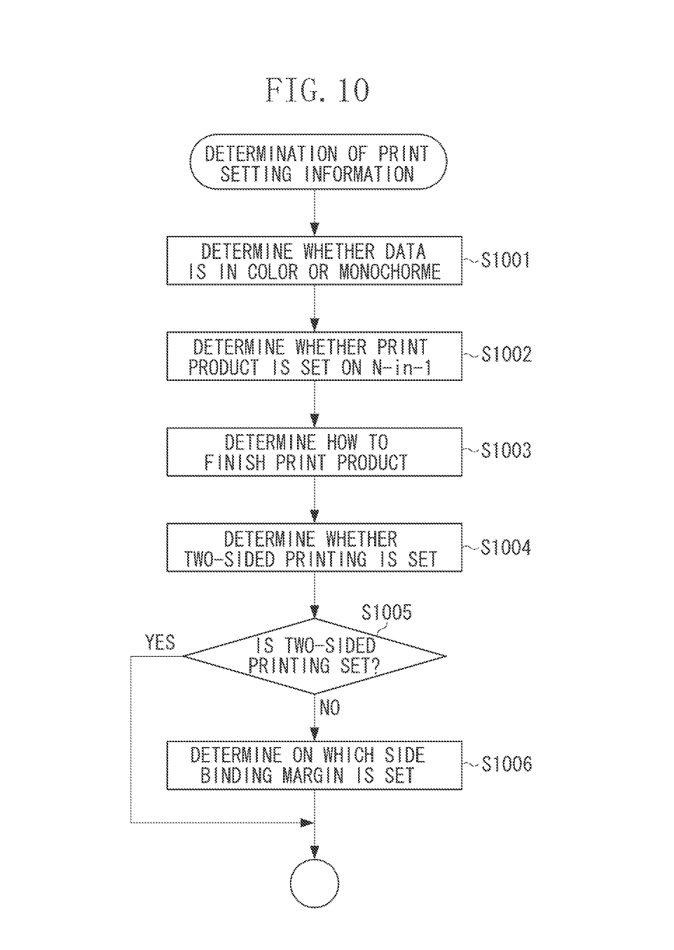

In step S805, the print setting control unit 214 determines the print setting information based on the image data and the hint information received in step S801. The details of the process performed in step S805 is described below with reference to FIG. 10.

In step S1001, the print setting control unit 214 determines whether the data is in color or monochrome from the pixel value of the image data.

In step S1002, the print setting control unit 214 determines whether the target image is set to N-in-1. As described above, the image 900 is an example of the 4-in-1 printing in which four logic pages 901 to 904 are arranged in one physical page. The image analysis unit 213 extracts a background area from the image 900. A white portion of the image 920 indicates the extracted background area. The image 920 is the same as the image 900. The image 920 is just an image for describing the background area. In the present exemplary embodiment, it can be found that the physical page is divided into four parts to form the background area by setting the 4-in-1. The physical page is divided into two parts by setting 2-in-1. Then, the physical page is divided into six parts by setting 6-in-1. In this way, the print setting control unit 214 determines whether the N-in-1 setting is made according to the number of divisions of the physical page from the background area.

In step S1003, the print setting control unit 214 determines the finishing setting based on the image 920 extracted in step S1002. The finishing setting to be determined includes stapling, punching, user information output to an area outside a print range, and a page number. The print setting control unit 214 determines whether a staple setting is made on the target image 900 based on image analysis results of the four corners of the image 920 area made by the image analysis unit 213. The print setting control unit 214 determines whether punching is set on the target image 900 by the image analysis unit 213 analyzing areas near the center of four sides of the image 920 area. The print setting control unit 214 determines whether user information and/or page number are added to the target image 900 by the image analysis unit 213 analyzing the upper and lower edges of the image 920 area.

Instep S1004, the print setting control unit 214 determines whether two-sided printing is set based on the image 920 extracted in step S1002. The image analysis unit 213 lowers the luminance of the image 900 to generate a new target image for comparison, and compares the new target image with the image 900 generated in step S1002. Thereafter, if a difference exceeding a certain threshold is found, the print setting control unit 214 determines that the two-sided printing is set. Even if the print setting control unit 214 determines that the two-sided printing is not set, but if the print setting control unit 214 determines that the N-in-1 setting is made in step S1002, the print setting control unit 214 may determine that the two-sided printing is set. This is because the user who sets the N-in-1 printing may intend to save the consumption of paper, and it is likely that the user also sets the two-sided printing. If the print setting control unit 214 determines that the two-sided printing is set according to the result of step S1004 (YES in step S1005), the process proceeds to step S1006. If the print setting control unit 214 determines that the two-sided printing is not set (NO in step S1005), the process is ended.

Instep S1006, the image analysis unit 213 determines a binding direction based on a difference image acquired from a resultant luminance difference in step S1004. The image analysis unit 213 performs a segmentation process on the difference image to extract a character area. The image analysis unit 213 then applies an optical character recognition (OCR) process to the extracted character. As a result of the process, if the character is reversed, the print setting control unit 214 determines that a short-side binding is set. If the character is reversed and upside down, the print setting control unit 214 determines that a long-side binding is set. Also in step S1004, it is determined whether the two-sided printing is set by using the method described above. In the present exemplary embodiment, the target print product is regarded as a landscape print product. However, if the target print product is a portrait, the print setting control unit 214 determines that the long-side binding is set if the extracted character is reversed, and determines that the short-side binding is set if the extracted character is reversed and upside down.

In step S806, the management unit 211 generates the original data acquired in the above steps and the print setting information 600, and the network control unit 215 transmits the data to the printing control apparatus 100. The print setting information 600 illustrated in FIG. 6A is an example of print setting information exchanged between the printing control apparatus 100 and the information processing apparatus 110 according to the present exemplary embodiment. The print setting item 601 indicates each print setting item. The items of paper size and finishing 1 are results acquired in steps S402 and S403. The items of color/monochrome, N-in-1, finishing 2, two sided, and binding direction are results acquired in steps S1001 to S1006. Each of the determination results is illustrated as the determination result 602.

As described above, the print setting added to the print product whose image is captured by the user can be acquired by the printing control apparatus 100 and the information processing apparatus 110. This can save the time for inputting various print settings in reprinting, and improve operability.

In the present exemplary embodiment, the camera is used as an image sensor, but a scanner may be used. In this case, a part of the print settings such as paper size, bookbinding, and folding, which is larger than the document positioning plate of the scanner, cannot be determined. However, other print settings can be determined to obtain similar effects to those obtained in the present embodiment. The case where the part of the print settings cannot be determined is described in detail in a second exemplary embodiment. However, this can be solved also by urging the user to input the print setting.

In the first exemplary embodiment, the preview image is displayed in which the print setting information added to the original data and the print product is reflected by the printing control apparatus 100 and the information processing apparatus 110.

In a second exemplary embodiment, an example is described in which, if there is a setting value of the print setting information that cannot be acquired in the first exemplary embodiment, the user is urged (hereinafter referred to as “to recommend”) to input a setting value of unclear print setting information at the time of preview.

FIG. 6B illustrates the print setting information of the present exemplary embodiment to which the print setting information described with reference to FIG. 6A in the first exemplary embodiment is enlarged. For the information in a recommendation column 613, a flag requiring recommendation is set on the setting value that cannot be determined by the image capture control unit 204 in steps S402 and S403. Furthermore, a flag requiring recommendation is set on the setting value that cannot be determined by the print setting control unit 214 in steps S1001 to S1006. In the present exemplary embodiment, an example is described below in which the print setting control unit 214 cannot determine settings for the two-sided printing and the binding direction.

The present exemplary embodiment is similar in hardware and software configuration to the first exemplary embodiment, and thus the description thereof is omitted.

In the flow chart of the information processing apparatus 110 according to the present exemplary embodiment, if the setting value of the print setting information cannot be determined, this is input to the determination result of the print setting information. Other than this point, the flow chart thereof is similar to that of the first exemplary embodiment, so that the description thereof is omitted. In the present exemplary embodiment, the print setting control unit 214 can determine neither the two-sided setting in step S1004 nor the binding-direction setting in step S1006, and thus the management unit 211 takes the determination results of the two-sided setting and the binding-direction setting as unclear. The management unit 211 sets 1 to a recommendation column 613 of the corresponding item to generate print setting information 610 For the sake of simplicity, when a determination result is unclear, 1 is set to a recommendation column. However, the management unit 211 does not necessarily needs to set 1 to the recommendation column 613 if it is found that the determination result is unclear but recommendation is required.

In steps S301 to S305 in the flow chart of the printing control apparatus 100, if the print setting cannot be determined, the information processing apparatus 110 is notified of the determination result that the print setting cannot be determined. Other than this point, the flow chart thereof is similar to that of the first exemplary embodiment, so that the description thereof is omitted.

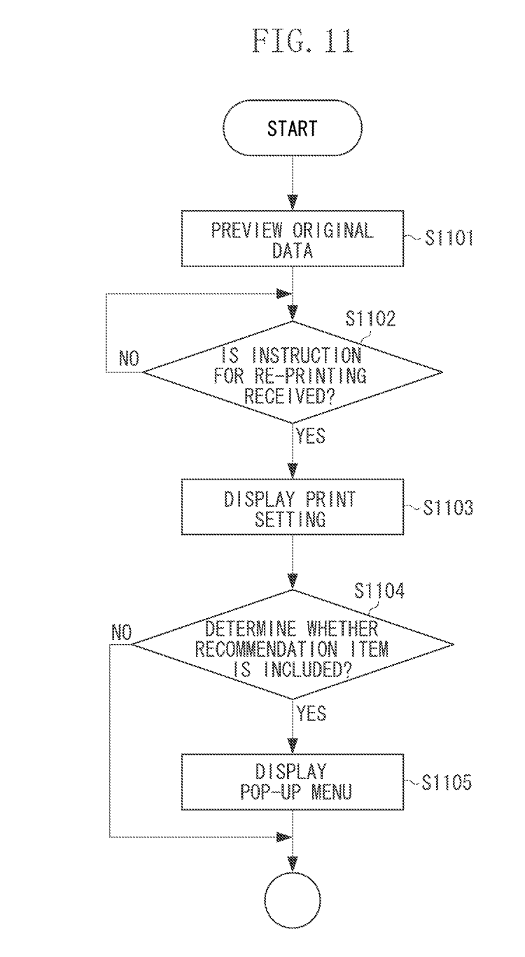

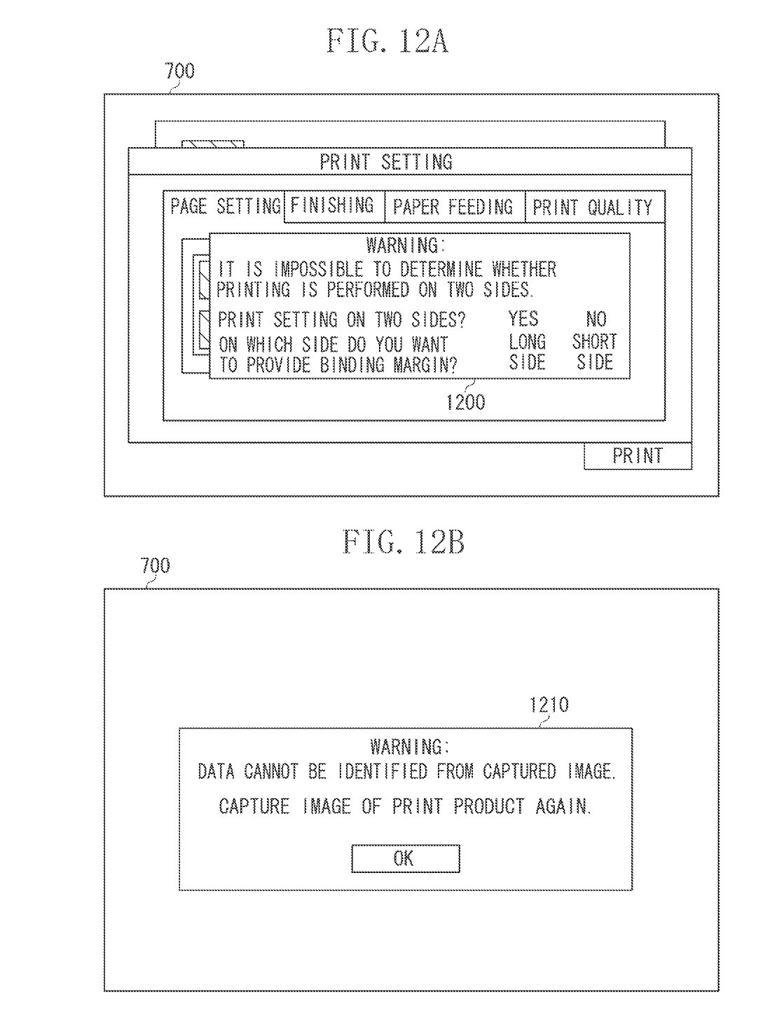

FIG. 11 is a flow chart illustrating the process of step S306 according to the present exemplary embodiment. FIG. 12 illustrates results thereof.

In step S1101, the image control unit 202 performs the low resolution rendering on the received original data, and the display unit 205 previews the rendered results.

In step S1102, the display unit 205 receives an instruction for re-printing from the user. If the display unit 205 receives the instruction for re-printing (YES in step S1102), the process proceeds to step S1103. The reception of the instruction for re-printing from the user is triggered by, for example, pressing of the print button 703 displayed on the display panel 700 described in the first exemplary embodiment.

In step S1103, the display unit 205 displays the received print setting information. The image of the received print setting information is illustrated in FIG. 7B described in the first exemplary embodiment. As described in the first exemplary embodiment, the print setting window 710 serves to display the received print setting information for the user. The user can acquire a desired print result by confirming or changing an item displayed in the window and then issuing a print instruction.

In step S1104, the display unit 205 confirms whether there is a setting item whose recommendation item 613 is set to 1 in the print setting information 610. If all of the recommendation items 613 are set to 0 (NO in step S1104), the process is ended. If any one of the recommendation items 613 is set to 1 (YES in step S1104), the process proceeds to step S1105.

In step S1105, the display unit 205 notifies the user that a setting value is not reflected in the setting item to be recommended, which is illustrated in FIG. 12A. A warning window 1200 is a window for notifying the user of the item in which the setting value of the print setting information is not reflected, and urging the user to perform setting. The display unit 205 sets a corresponding setting pair if the user receives a print setting request, in response to the notification. In the present exemplary embodiment, it is set whether to perform two-sided setting and binding margin setting which are recommended.

In steps S1101 and S1103, if the received original data and the print setting information are erroneous or the display unit 205 receives an error from the information processing apparatus 110, the display unit 205 notifies the user that the image of the print product is to be captured again. FIG. 12B illustrates a case where the original data cannot be found, as an example. In this case, the display panel 700 displays a warning window 1210. The warning window 1210 displays an error content received by the printing control apparatus 100 and notifies the user that the image of the print product is to be captured again.

In the present exemplary embodiment, a window is displayed as recommendation on the display unit 205 to give the user a warning. If the display unit 205 has a function to notify the user that the print setting is not set in such a manner that the print setting to be recommended is highlighted on the screen at the time of setting the print setting, for example, the method of warning does not necessarily need to be displayed in such a manner.

The example described above is the case where recommendation is made if the print setting cannot be determined. However, in the present exemplary embodiment, the user can preliminarily set whether to make recommendation. In a case where the user sets the recommendation as unnecessary, even if a recommendation flag is set on the print setting information, the printing control apparatus 100 uses a default setting value without notifying the user.

If the two-sided setting cannot be determined, and if the N-in-1 is set as the default print setting, the two-sided setting may be set.

In the present exemplary embodiments, the information processing apparatus 110 extracts the feature quantity based on the received image data in step S802, searches for the original data in step S803, and then determines the print setting in step S805. These processes, however, may be reversed in order.

In the present exemplary embodiments, when the printing control apparatus 100 transfers data to the information processing apparatus 110, the printing control apparatus 100 transfers the image data and the print setting information determined by the printing control apparatus 100 thereto. However, instead of the image data, the feature quantity of the image data may be transferred thereto by the printing control apparatus 100 performing the processes in steps S802 and S805, which are the processes performed by the information processing apparatus 110, between steps S302 and S303. This process eliminates the need for transferring the image data large in size, and the print control apparatus 100 only has to transfer the feature quantity small in size, which allows a transfer cost to be suppressed.

In the present exemplary embodiments, for the sake of simplicity, the printing control apparatus 100 and the information processing apparatus 110 are separately described. However, the software module 210 of the information processing apparatus 110 may be mounted on the printing control apparatus 100 to obtain the effects of the present exemplary embodiments only with the printing control apparatus 100. In this case, communication between the modules is performed not via the network IFs 105 and 114 but via an internal bus.

The present specification describes above that the original data is acquired from the image data of the captured print product, and the print setting information acquired by determining the image data is added to the original data, which allows reprinting using the same print setting information. However, if the user wants to perform reprinting of the captured print product using not the same print setting but only a part of setting pairs such as paper size, color/monochrome, and N-in-1, the information processing apparatus 110 has only to transfer the corresponding image data to the printing control apparatus 100 as it is. As described above, the printing control apparatus 100 transfers the image data generated in step S307 to the information processing apparatus 110. This means that the transferred image data is transferred to the printing control apparatus 100 as it is. In the effect acquired by the process, it is impossible to reflect the print setting which is not included in the image data stored in the memory such as stapling and bookbinding, but it is possible to quickly provide the print product imaged by the user because the print setting does not need determination by the image analysis.

The present exemplary embodiments described above allow the operation burden of the user to be reduced at the reprinting.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-261496 filed Dec. 18, 2013, which is hereby incorporated by reference herein in its entirety.

What is claimed is:

1. A printing system including a printing control apparatus and an information processing apparatus, the printing control apparatus comprising:
a printing unit configured to print a print product;
an imaging unit configured to image the print product; and
a transmission unit configured to transmit a result of analyzing image data acquired by imaging the print product and the image data to the information processing apparatus, and
the information processing apparatus comprising:
a storage unit configured to store original data used for printing;
a determination unit configured to determine print setting information set for printing the imaged print product based on the image data and the result of analysis;
a search unit configured to search for the original data based on the image data; and
a data transmission unit configured to transmit the original data found by the search unit and the determined print setting information to the printing control apparatus,
wherein the printing unit prints the print product based on the original data and the print setting information.

2. The printing system according to claim 1, wherein the result of analysis includes a size of paper used for the imaged print product and a finishing setting set for printing the print product.

3. The printing system according to claim 1, wherein the determination unit sets a flag on an item whose setting value cannot be determined among a plurality of print setting items, and the printing control apparatus displays a setting screen configured to receive a setting of the item whose setting value cannot be determined in a case where the printing control apparatus receives the print setting information on which the flag is set.

4. The printing system according to claim 1, wherein the determination unit determines whether two-sided printing is set based on the image data and image data for comparison that is generated by lowering luminance of the image data.

5. The printing system according to claim 1, wherein the printing control apparatus displays a preview image based on the original data in a case where the printing control apparatus receives the original data and the print setting information, and displays a setting screen in which the print setting information is reflected.

6. A method for controlling a printing system including a printing control apparatus and an information processing apparatus, the method executed by the printing control apparatus, comprising:
printing a print product;
imaging the print product; and
transmitting a result of analyzing image data acquired by imaging the print product and the image data to the information processing apparatus, and
the method executed by the information processing apparatus, comprising:
storing original data used for printing;
determining print setting information set for printing the imaged print product based on the image data and the result of analysis;
searching for the original data based on the image data; and
transmitting the original data found by the searching and the determined print setting information to the printing control apparatus,
wherein, in the printing, the print product is printed based on the original data and the print setting information.

7. The method for controlling the printing system according to claim 6, wherein the result of analysis includes a size of paper used for the imaged print product and a finishing setting set for printing the print product.

8. The method for controlling the printing system according to claim 6, wherein, in the determining, a flag is set on an item whose setting value cannot be determined among a plurality of print setting items, and the printing control apparatus displays a setting screen for receiving a setting of the item whose setting value cannot be determined in a case where the printing control apparatus receives the print setting information on which the flag is set.

9. The method for controlling the printing system according to claim 6, wherein, in the determining, it is determined whether two-sided printing is set based on the image data and image data for comparison that is generated by lowering luminance of the image data.

10. The method for controlling the printing system according to claim 6, wherein the printing control apparatus displays a preview image based on the original data in a case where the printing control apparatus receives the original data and the print setting information, and displays a setting screen in which the print setting information is reflected.
